(19) United States
(12) Patent Application Publication
(10) Pub. No.: US 2021/0256382 A1
(43) Pub. Date: Aug. 19, 2021

(54) LEARNING APPARATUS, IMAGE RECOGNITION APPARATUS, CONTROL METHOD FOR LEARNING APPARATUS, CONTROL METHOD FOR IMAGE RECOGNITION APPARATUS, AND STORAGE MEDIA STORING PROGRAMS CAUSING A COMPUTER TO EXECUTE THESE CONTROL METHODS

(71) Applicant: CANON KABUSHIKI KAISHA, Tokyo (JP)

(72) Inventor: Ryuichi Ishikuri, Kanagawa (JP)

(21) Appl. No.: 17/152,059

(22) Filed: Jan. 19, 2021

(30) Foreign Application Priority Data
Feb. 19, 2020 (JP) 2020-026507

(51) Int. Cl. G06N 3/08; G06K 9/62

(52) U.S. Cl. CPC G06N 3/082; G06K 9/00664; G06K 9/6227

(57) ABSTRACT

A learning apparatus that is capable of mounting a learned model in accordance with performance of an image recognition apparatus. The learning apparatus includes a reception unit, an adjustment unit, a learning unit, a transmission unit. The reception unit receives information about processing capability and at least one recognition target of the image recognition apparatus from the image recognition apparatus concerned. The adjustment unit adjusts a configuration of a learning model applied to image recognition of the at least one recognition target so as to satisfy the processing capability. The learning unit generates a first learned model that is able to recognize the at least one recognition target by performing machine learning of the adjusted learning model. The transmission unit transmits the first learned model to the image recognition apparatus.

### BACKGROUND OF THE INVENTION

### Field of the Invention

The present invention relates to a learning apparatus, an image recognition apparatus, a control method for the learning apparatus, a control method for the image recognition apparatus, and storage media storing programs causing a computer to execute these control methods.

### Description of the Related Art

In recent years, deep learning based on a convolutional neural network (CNN) model is applied to image recognition. The CNN model improves accuracy of image recognition by performing machine learning using much learned data. Japanese Laid-Open Patent Publication (Kokai) No. H10-063633 (JP H10-063633A) proposes a related technique. The technique of this publication is configured to determine an upper limit and lower limit of a data table of a sigmoid function that defines an output value of each neuron of a neural network according to a resolution of the data table.

Since a CNN model with high image recognition accuracy has large data size in general, high performance is required for a processor to perform an inference process of image recognition. In the meantime, since an edge device (an image recognition apparatus) like an eyeglass-type wearable device is poor in a hardware resource, it is difficult to perform image recognition using a high-accuracy CNN model. The above problem may occur not only in a CNN model but in arbitrary learning models.

### SUMMARY OF THE INVENTION

The present invention provides a technique of mounting a learned model in accordance with performance of an image recognition apparatus in the image recognition apparatus.

Accordingly, a first aspect of the present invention provides a learning apparatus including a reception unit configured to receive information about processing capability and at least one recognition target of an image recognition apparatus from the image recognition apparatus concerned, an adjustment unit configured to adjust a configuration of a learning model applied to image recognition of the at least one recognition target so as to satisfy the processing capability, a learning unit configured to generate a first learned model that is able to recognize the at least one recognition target by performing machine learning of the adjusted learning model, and a transmission unit configured to transmit the first learned model to the image recognition apparatus.

Accordingly, a second aspect of the present invention provides an image recognition apparatus including a transmission unit configured to transmit information about processing capability and at least one recognition target of the image recognition apparatus to a learning apparatus, a reception unit configured to receive a learned model that is able to recognize the at least one recognition target and is generated by adjusting a configuration of a learning model applied to image recognition of the at least one recognition target so as to satisfy the processing capability and by performing machine learning of the adjusted learning model, and an image recognition unit configured to perform the image recognition using the learned model.

Accordingly, a third aspect of the present invention provides a control method for a learning apparatus, the control method including a step of receiving information about processing capability and at least one recognition target of an image recognition apparatus from the image recognition apparatus concerned, a step of adjusting a configuration of a learning model applied to image recognition of the at least one recognition target so as to satisfy the processing capability, a step of generating a learned model that is able to recognize the at least one recognition target by performing machine learning of the adjusted learning model, and a step of transmitting the first learned model to the image recognition apparatus.

Accordingly, a fourth aspect of the present invention provides a control method for an image recognition apparatus, the control method including a step of transmitting information about processing capability and at least one recognition target of the image recognition apparatus to a learning apparatus, a step of receiving a learned model that is able to recognize the at least one recognition target and is generated by adjusting a configuration of a learning model applied to image recognition of the at least one recognition target so as to satisfy the processing capability and by performing machine learning of the adjusted learning model, and a step of performing the image recognition using the learned model.

Accordingly, a fifth aspect of the present invention provides a non-transitory computer-readable storage medium storing a control program causing a computer to execute the control method of the third aspect.

Accordingly, a sixth aspect of the present invention provides a non-transitory computer-readable storage medium storing a control program causing a computer to execute the control method of the fourth aspect.

According to the present invention, the learned model in accordance with the performance of the image recognition apparatus is mounted on the image recognition apparatus.

Further features of the present invention will become apparent from the following description of exemplary embodiments with reference to the attached drawings.

### BRIEF DESCRIPTION OF THE DRAWINGS

FIG. 1 is a block diagram showing one example of a system concerning an embodiment of the present invention.

FIG. 2 is a sequence chart showing a flow of a process of the entire system of FIG. 1.

FIG. 3 is a flowchart showing a flow of a process of a learning server in FIG. 1.

FIG. 4 is a flowchart showing a flow of a process of an eyeglass-type object recognition device in FIG. 1.

### DESCRIPTION OF THE EMBODIMENTS

Hereafter, an embodiment according to the present invention will be described in detail by referring to the drawings. Configurations described in the following embodiment is only an example, and the scope of the present invention is not limited by the configurations described in the embodiment.

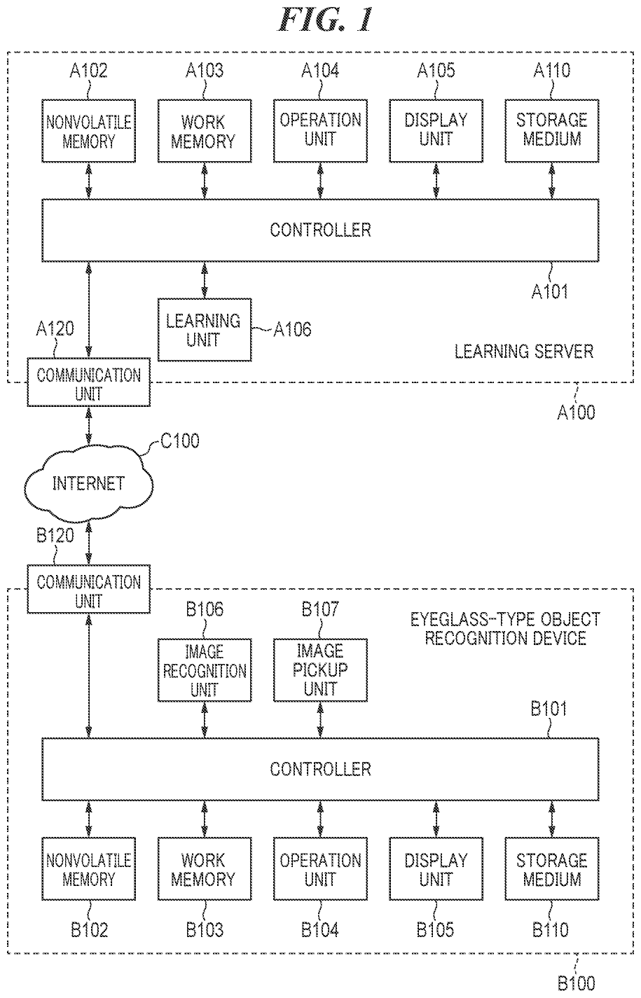

FIG. 1 is a block diagram showing one example of a system concerning the embodiment of the present invention. The system of this embodiment has a learning server A100 and an eyeglass-type object recognition device B100. The learning server A100 and the eyeglass-type object recognition device B100 are communicable mutually through the Internet C100. The learning server A100 is a learning apparatus that generates a learned model mounted on the eyeglass-type object recognition device B100 by performing machine learning and that transmits the generated learned model to the eyeglass-type object recognition device B100. The learning server A100 may be a cloud server etc., for example.

The eyeglass-type object recognition device B100 is an eyeglass-type wearable device and is an image recognition apparatus as an edge device. The image recognition apparatus may be an arbitrary device, such as a portable personal computer, a smart phone, a tablet terminal, a media player, or an image pickup apparatus. In this embodiment, hardware resources of the image recognition apparatus shall be poorer than hardware resources of the learning server A100.

The learning server A100 is described first. A controller A101 integrally controls the entire learning server A100. The controller A101 is achieved by a CPU, for example. Control of the entire learning server A100 may be performed by the controller A101 or may be performed by a plurality of hardware resources that share processes. A nonvolatile memory A102 is electrically recordable and erasable and stores programs that the controller A101 runs. A work memory A103 is used as a buffer memory used for a learning process, an image display memory for a display unit A105, a working area of the controller A101, etc. A function of the controller A101 may be achieved by the CPU running the program developed to the work memory A103.

An operation unit A104 is used to receive an instruction from a user to the learning server A100. The operation unit A104 includes a power button of the learning server A100, a keyboard, a mouse, etc., for example. The display unit A105 displays predetermined information. For example, the display unit A105 displays learning data, a screen for a GUI (Graphical User Interface) for an interactive operation, etc. The display unit A105 may be an external display device outside the learning server A100. In this case, the learning server A100 and the display device are connected. Then, a display content of the display device is controlled by the learning server A100.

A learning unit A106 performs machine learning of a learning model. A learning model is recorded in a recording medium A110, for example. In this embodiment, the learning unit A106 performs machine learning (deep learning) based on a convolutional neural network (CNN), and generates a learned model suitable for object recognition. The learning unit A106 may perform a learning process by applying arbitrary machine learning algorithms, such as a decision tree, a support vector machine, and a logistics revolution. The learning unit A106 may be achieved by a GPU (Graphics Processing Unit) or may be achieved by cooperation of a CPU and GPU.

A learned CNN model that has been subjected to the machine learning is used for an inference process that reasons an output value from an input value. When performing the machine learning of a CNN model, the learning unit A106 performs supervised learning of which an input is image data and teacher data is tag information of an object included in the input image data. The tag information is “a car”, “trees”, “a person”, “a dog”, or the like, for example. Hereinafter, a combination of image data used as an input value and tag information used as teacher data is called a learning set. The learning unit A106 performs the machine learning of the CNN model using many learning sets. The learning unit A106 performs the machine learning of the CNN model using an error back propagation method etc.

Many learning sets are stored in the recording medium A110. The recording medium A110 corresponds to a recording unit. The recording medium A110 may be configured so as to be detachably attached to the learning server A100 or may be built in the learning server A100. The learning server A100 is able to access the recording medium A110. It should be noted that the learning sets may be recorded in a recording unit (for example, the nonvolatile memory A102) other than the recording medium A110.

A communication unit A120 communicates with the eyeglass-type object recognition device B100 through the Internet C100. The communication unit A120 corresponds to a reception unit and a transmission unit. The communication unit A120 is an interface that performs a wireless LAN communication based on the IEEE802.11 standard, for example. The communication unit A120 performs wireless communication with an access point by a wireless LAN communication. Moreover, the communication unit A120 transmits and receives data with a device that is connected to the cloud network through the access point by a high order protocol, such as the TIP/IP. It should be noted that the communication method of the communication unit A120 is not limited to the above-mentioned example.

Next, the eyeglass-type object recognition device B100 will be described. The controller B101 integrally controls the entire eyeglass-type object recognition device B100. The controller B101 is achieved by a CPU, for example. Control of the entire eyeglass-type object recognition device B100 may be performed by the controller B101 or may be performed by a plurality of hardware resources that share processes. A nonvolatile memory B102 is electrically recordable and erasable and stores programs that the controller B101 runs. A work memory B103 is used as a buffer memory used for a learning process, an image display memory for a display unit B105, a working area of the controller B101, etc. A function of the controller B101 may be achieved by the CPU running the program developed to the work memory B103.

An operation unit B104 is used to receive an instruction from a user to the eyeglass-type object recognition device B100. The operation unit B104 includes a power button of the eyeglass-type object recognition device B100, and a manual operation button, for example. The display unit B105 displays predetermined information. For example, the display unit B105 displays learned data, the screen for GUI for an interactive operation, etc. When the image recognition apparatus is not the eyeglass-type object recognition device B100, the display unit B105 may be provided as an external display device that is communicable with the image recognition apparatus.

The image pickup unit B107 picks up an image and generates image data. In this embodiment, the image pickup unit B107 is provided in the front side of the glasses and picks up an image that is the same field angle as what the user looks. The image pickup unit B107 passes the image data generated by the image pickup operation to the image recognition unit B106. The image recognition unit B106 is an image recognition unit that performs the image recognition of the image data picked up by the image pickup unit B107 by reasoning. The image recognition unit B106 performs the recognition process using the learned model transmitted from the learning server A100. The image recognition unit 106 may be achieved by a GPU or may be achieved by cooperation of a CPU and GPU.

The recording medium B110 records the learned model obtained from the learning server A100. As mentioned above, in this embodiment, the learned model is the learned CNN model. The recording medium B110 may be configured so as to be detachably attached to the eyeglass-type object recognition device B100 or may be built in the eyeglass-type object recognition device B100. The eyeglass-type object recognition device B100 is able to access the recording medium A110. It should be noted that the learned model may be recorded in a recording unit (for example, the nonvolatile memory B102) other than the recording medium B110.

A communication unit B120 communicates with the learning server A100 through the Internet C100. The communication unit B120 corresponds to a reception unit and a transmission unit. The communication unit B120 is an interface that performs a wireless LAN communication based on the IEEE802.11 standard, for example. The communication unit B120 performs wireless communication with an access point by a wireless LAN communication. Moreover, the communication unit B120 transmits and receives data with a device that is connected to the cloud network through the access point by a high order protocol, such as the TIP/IP. It should be noted that the communication method of the communication unit B120 is not limited to the above-mentioned example.

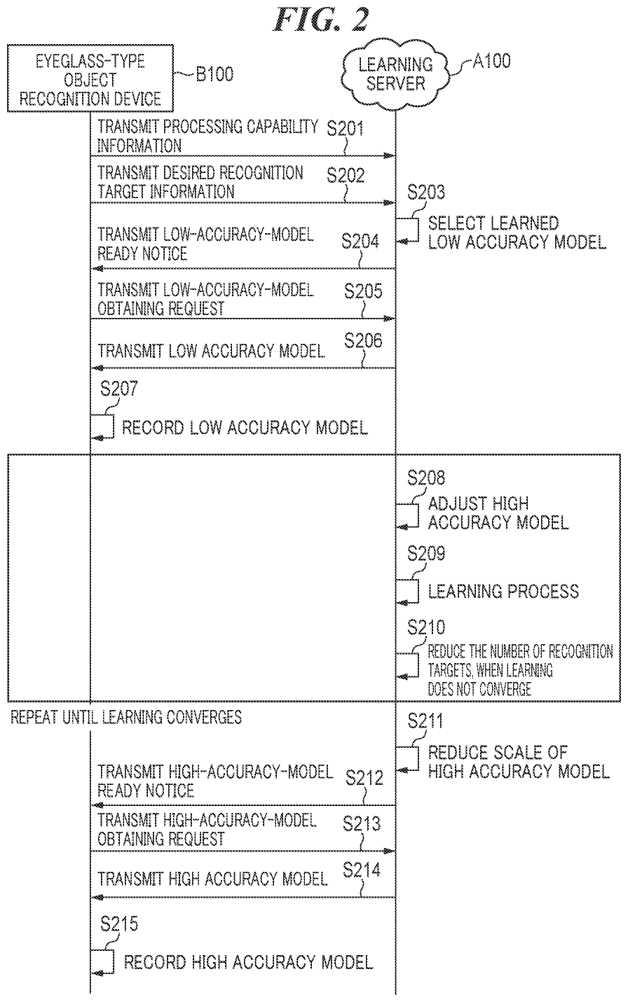

Next, the flow of the process of the entire system of this embodiment will be described. FIG. 2 is a sequence chart showing the flow of the process of the entire system. The controller B101 of the eyeglass-type object recognition device B100 controls the communication unit B120 to transmit processing capability information in S201. Thereby, the processing capability information is transmitted to the learning server A100 from the eyeglass-type object recognition device B100. The processing capability information may be information about an operating frequency of the controller B101 used for an operation of the image recognition unit B106 or may be information about the memory size of the nonvolatile memory B102 or the work memory B103. The processing capability information is also an index that shows the processing capability at a time when the image recognition unit B106 performs the inference process of the image recognition.

In S202, the controller B101 controls to transmit desired recognition target information to the learning server A100. Although the following description assumes that there are a plurality of desired recognition targets (recognition targets), there may be one desired recognition target. Thereby, the information about the desired recognition targets is transmitted to the learning server A100 from the eyeglass-type object recognition device B100. The information about the desired recognition targets is a list in which the recognition targets by the image recognition unit B106 are registered in a priority order. In this embodiment, the highest priority (priority 1) is a “car”, and the second highest priority (priority 2) is a “person”, and the lowest priority (priority 3) is a “dog”. The number of recognition targets is not limited to three. Moreover, the recognition targets are not limited to the above-mentioned example.

In S203, the controller A101 selects a low-accuracy learned model that satisfies the processing capability information received in S201 and the desired recognition target received in S202. In this embodiment, learned models shall be beforehand recorded in the recording medium A110 for the respective processing capabilities and for the respective recognition targets. The controller A101 selects the low-accuracy learned model that enables recognition of the desired recognition targets by the processing capability of the eyeglass-type object recognition device B100 on the basis of the processing capability information received from the eyeglass-type object recognition device B100 and the information about the desired recognition targets. The low-accuracy learned model corresponds to a second learned model.

In S204, the controller A101 controls to transmit a low-accuracy-model ready notice to the eyeglass-type object recognition device B100. The notice shows that transmission of the low-accuracy learned model is readied. Thereby, the low-accuracy-model ready notice is transmitted to the eyeglass-type object recognition device B100 from the learning server A100. In S205, the controller B101 of the eyeglass-type object recognition device B100 controls to transmit a request to obtain the low-accuracy learned model to the learning server A100 in response to the received low-accuracy-model ready notice. Thereby, the request (low-accuracy-model obtaining request) to obtain a low-accuracy learned model is transmitted from the eyeglass-type object recognition device B100 to the learning server A100.

In S206, the controller A101 of the learning server A100 controls to transmit the low-accuracy learned model (low accuracy model) in response to the low-accuracy-model obtaining request. Thereby, the low-accuracy learned model is transmitted to the eyeglass-type object recognition device B100 from the learning server A100. In S207, the controller B101 of the eyeglass-type object recognition device B100 records the low-accuracy learned model received from the learning server A100 in the recording medium B110. Thereby, the eyeglass-type object recognition device B100 is able to perform the object recognition using the low-accuracy learned model until obtaining a high-accuracy learned model mentioned later.

In S208, the controller A101 of the learning server A100 adjusts a high-accuracy learning model. The high-accuracy learning model is recorded in the recording medium A110, for example. The controller A101 adjusts a learning model so that the processing capability received in S201 and the information about the desired recognition targets received in S202 will be satisfied as much as possible. That is, the controller A101 adjusts the learning model so as to satisfy the processing capability of the eyeglass-type object recognition device B100 and so as to enable recognition of at least one of the desired recognition targets. The controller A101 may adjust the high-accuracy learning model so that a data size and a calculation amount of the high-accuracy learning model will become below the processing capability of the eyeglass-type object recognition device B100.

For example, the controller A101 adjusts configurations and parameters, such as the numbers of synapses and layers that constitute the CNN, a grain size of an output value of a firing function of each synapse, or the like. Thereby, the configurations and parameters of the learning model are adjusted. For example, the controller A101 controls the high-accuracy learning model within the processing capability of the eyeglass-type object recognition device B100 by reducing the numbers of synapses and layers that constitute the CNN. Moreover, the controller A101 controls the high-accuracy learning model within the processing capability of the eyeglass-type object recognition device B100 by roughening a grain size of an output value of a firing function of each synapse that constitutes the CNN.

In S209, the controller A101 controls the learning unit A106 to perform the machine learning of the adjusted high-accuracy learning model. The process of S209 is a learning process. As mentioned above, the learning unit A106 performs supervised learning of which an input is image data and teacher data is tag information of an object included in the input image data. The learning unit A106 may perform the machine learning of the learning model using the error back propagation method etc. Thereby, the high-accuracy learning model is mechanically learned, and a high-accuracy learned model is generated. The high-accuracy learned model corresponds to a first learned model.

In S210, the controller A101 determines whether the learning converges. When the learning does not converge, the controller A101 delete a recognition target. Convergence of the learning will be mentioned later. When determining that the learning does not converge, the controller A101 returns the process to S208 and readjusts the high-accuracy learning model. At this time, the controller A101 deletes a desired recognition target that has the lowest priority from among the desired recognition targets that are designated by the desired recognition target information received from the eyeglass-type object recognition device B100. In the above-mentioned case, the controller A101 excepts the “dog” that has the lowest priority 3 from the recognition targets. Then, the controller A101 performs the learning process of S209, and determines again whether the learning converges in S210. The controller A101 repeats the processes from S208 to S210 until determining that the learning converges in S210.

In S211, the controller A101 reduces the scale of the high-accuracy learned model generated by the processes from S208 to S210. In S212, the controller A101 controls to transmit the high-accuracy-model ready notice, which shows that the transmission of the high-accuracy learned model is readied, to the eyeglass-type object recognition device B100. Thereby, the high-accuracy model ready notice is transmitted to the eyeglass-type object recognition device B100 from the learning server A100. In S213, the controller B101 of the eyeglass-type object recognition device B100 controls to transmit the high-accuracy-model obtaining request, which is a request to obtain a high-accuracy learned model, to the learning server A100. Thereby, the high-accuracy-model obtaining request is transmitted to the eyeglass-type object recognition device B100 from the learning server A100. In S214, the controller A101 of the learning server A100 controls to transmit the high-accuracy learned model (high accuracy model) to the low-accuracy-model obtaining request to the eyeglass-type object recognition device B100. Thereby, the high-accuracy learned model is transmitted to the eyeglass-type object recognition device B100 from the learning server A100. In S215, the controller B101 of the eyeglass-type object recognition device B100 records the high-accuracy learned model received from the learning server A100 in the recording medium B110.

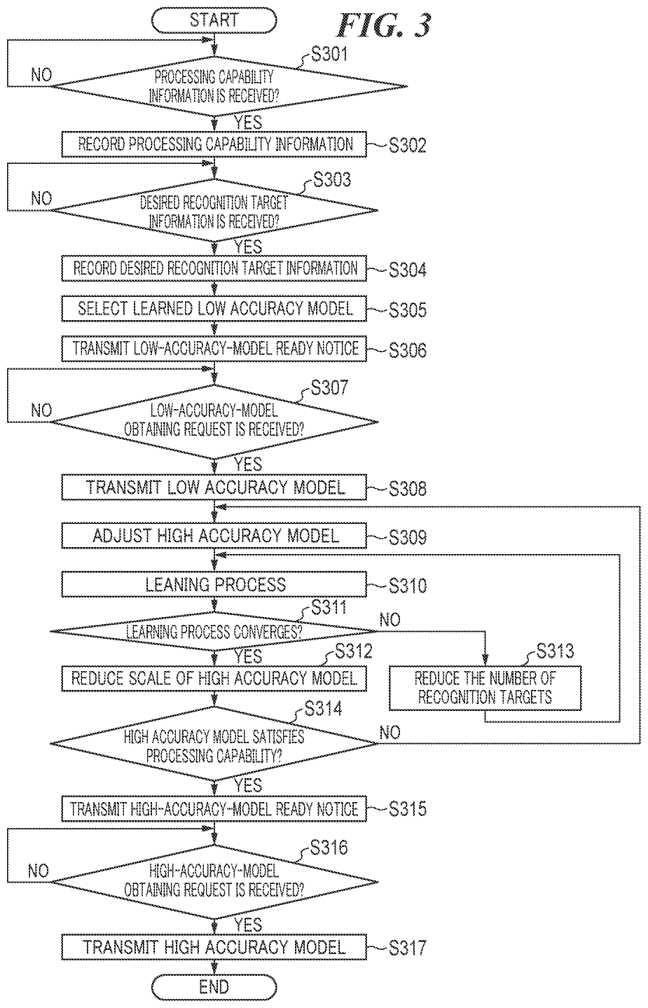

Next, the process executed by the learning server A100 will be described in detail. FIG. 3 is a flowchart showing a flow of the process of the learning server A100. In S301, the controller A101 determines whether the processing capability information is received from the eyeglass-type object recognition device B100 through the communication unit A120. When determining that the processing capability information is not received (No in S301), the controller A101 returns the process to S301 and waits until receiving the processing capability information. In the meantime, when determining that the processing capability information is received (Yes in S301), the controller A101 proceeds with the process to S302.

In S302, the controller A101 records the processing capability information received from the eyeglass-type object recognition device B100 in the recording medium A110. In S303, the controller A101 determines whether the desired recognition target information is received from the eyeglass-type object recognition device B100 through the communication unit A120. When determining that the desired recognition target information is not received (No in S303), the controller A101 returns the process to S303. In the meantime, when determining that the desired recognition target information is received (Yes in S303), the controller A101 proceeds with the process to S304. In S304, the controller A101 records the desired recognition target information received from the eyeglass-type object recognition device B100 in the recording medium A110.

In S305, the controller A101 selects a low-accuracy learned model, which satisfies the processing capability and the desired recognition targets of the eyeglass-type object recognition device B100, from among the low-accuracy learned models recorded in the recording medium A110. As mentioned above, the low-accuracy learned models that have been subjected to the machine learning are recorded in the recording medium A110 for the respective processing capabilities and for the respective recognition targets. Low-accuracy learned models that have been subjected to the machine learning may be recorded as learning sets that are combinations of various calculation amounts, data sizes, and recognition targets in the recording medium A110. The controller A101 selects a low-accuracy learned model, which satisfies the processing capability and the desired recognition targets of the eyeglass-type object recognition device B100, from among the low-accuracy learned models recorded in the recording medium A110.

In S305, the controller A101 may control the learning unit A106 to perform the learning process instead of selecting a low-accuracy learned model that satisfies conditions from among the low-accuracy learned models prepared beforehand. In this case, the learning unit A106 performs the learning process to generate a low-accuracy learned model that satisfies the conditions of the desired recognition target information received from the eyeglass-type object recognition device B100. In this case, the learning unit A106 generates a learned model of which a scale is sufficiently small with respect to the processing speed of the controller A101 in order to give priority to the generating time of a learned model rather than the recognition accuracy of a learned mode. That is, the learning unit A106 generates the small-scale learned model that is generable within a period required to perform a predetermined process by the controller A101 (CPU).

In S306, the controller A101 controls to transmit the low-accuracy-model ready notice to the eyeglass-type object recognition device B100 through the communication unit A120. In S307, the controller A101 determines whether the low-accuracy-model obtaining request is received from the eyeglass-type object recognition device B100 through the communication unit A120. When determining that the low-accuracy-model obtaining request is not received (No in S307), the controller A101 returns the process to S307. When determining that the low-accuracy-model obtaining request is received (Yes in S307), the controller A101 proceeds with the process to S308. In S308, the controller A101 controls to transmit a low accuracy model to the eyeglass-type object recognition device B100 through the communication unit A120. Thereby, the low-accuracy learned model is transmitted to the eyeglass-type object recognition device B100 from the learning server A100.

In S308, the controller A101 adjusts a high-accuracy learning model. At this time, the controller A101 adjusts the learning model so that the processing capability and the desired recognition tartlets received from the eyeglass-type object recognition device B100 will be satisfied as much as possible as mentioned above. In S310, the controller A101 controls the learning unit A106 to perform the machine learning of the high-accuracy learning model. Thereby, the high-accuracy learned model that enables recognition of the desired recognition targets is generated. When a desired recognition target with low priority is deleted from among the desired recognition tartlets, the high-accuracy learned model that enables recognition of the desired recognition targets that are not deleted is generated. In S311, the controller A101 determines whether the learning of S310 converges. When determining that the learning does not converge (No in S311), the controller A101 proceeds with the process to S313. In the meantime, when determining that the learning converges (Yes in S311), the controller A101 proceeds with the process to S314.

Convergence of the learning will be described. When performing the machine learning, the learning unit A106 performs the supervised learning of which an input is image data and teacher data is tag information of an object included in the input image data as mentioned above. In this case, the learning converges when the learning model comes to output the teacher data with respect to the image data input into the learning model. The learning may converge when difference between the teacher data and the output value from the learning model corresponding to the image data that is input into the learning model becomes below a certain value. In the meantime, when the learning model does not output the teacher data or when the difference between the teacher data and the output value corresponding to the image data that is input into the learning model does not become below the certain value, the learning does not converge.

In S312, the controller A101 performs the process that reduces the scale of the high-accuracy learned model. For example, the controller A101 may reduce the scale of the high-accuracy learned model by reducing resolution of a sigmoid function. This reduces the scale of the learned model while reducing the performance degradation of the learned model. Moreover, the controller A101 may reduce the scale of the learned model by employing a method called “pruning” that reduces low-importance neurons to an extent that trouble does not appear in reasoning accuracy.

In the meantime, the controller A101 performs a process that reduces the number of recognition targets of the learning model in S313. The calculation amount increases as the types of the output value of the learned model (types of tag information) increase. As a result, the data size of the learned model also increases. In order to prevent this, the controller A101 reduces the number of the recognition targets of the learning model. Then, the controller A101 returns the process to S310 and controls the learning unit A106 to perform the learning process again. Thereby, a probability of convergence of the learning becomes high because the number of the recognition targets of the learning model is reduced. As mentioned above, the controller A101 deletes from a low-priority recognition target when reducing the number of the recognition targets.

In S314, the controller A101 determines whether the high-accuracy learned model that has been subjected to the reduction process in S313 satisfies the processing capability shown by the processing capability information received from the eyeglass-type object recognition device B100. This determination process also determines whether the eyeglass-type object recognition device B100 is able to perform the inference process using the learned model that has been subjected to the reduction process. When the result of the determination of S314 is No, the controller A101 returns the process to S309. In the meantime, when the result of the determination of S314 is Yes, the controller A101 records the learned model in the recording medium A110 (an image-recognition-model storage unit) and proceeds with the process to S315.

In S315, the controller A101 controls to transmit the high-accuracy-model ready notice to the eyeglass-type object recognition device B100 through the communication unit A120. In S316, the controller A101 determines whether the high-accuracy-model obtaining request, which is a request to obtain the high-accuracy learned model, is received from the eyeglass-type object recognition device B100 through the communication module A120. When determining that the high-accuracy-model obtaining request is received (Yes in S316), the controller A101 proceeds with the process to S317. In the meantime, when determining that the high-accuracy-model obtaining request is not received (No in S316), the controller A101 returns the process to S316 and waits until receiving the high-accuracy-model obtaining request. At this time, the controller A101 may deletes a learned model recorded in the recording medium A110, when not receiving the high-accuracy-model obtaining request from the eyeglass-type object recognition device B100 within a predetermined period (for example, a day or an hour). In S317, the controller A101 controls to transmit a high-accuracy learned model to the eyeglass-type object recognition device B100 through the communication module A120.

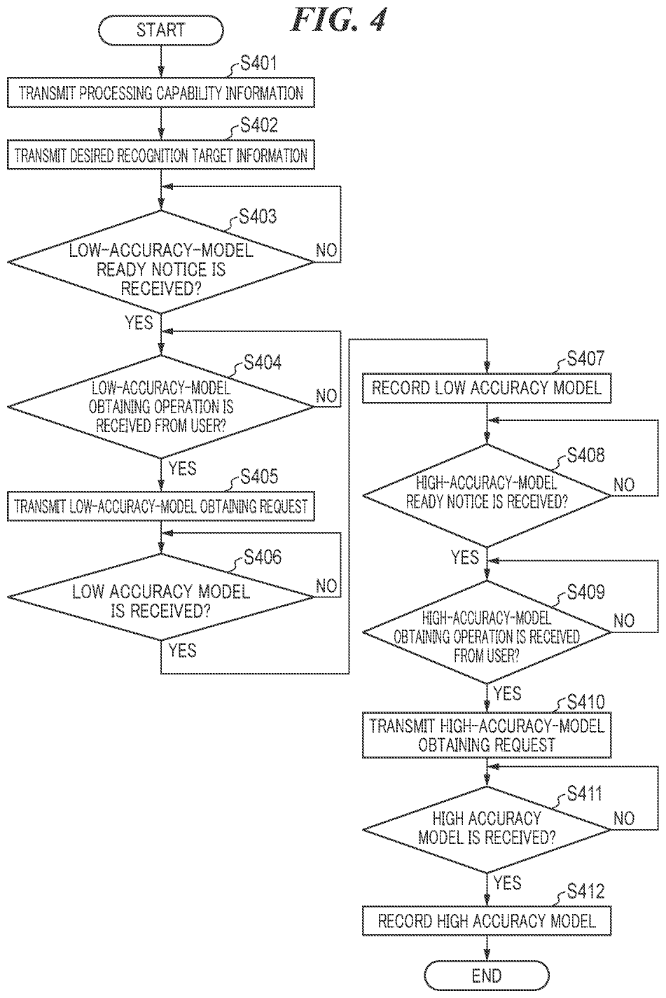

Next, a flow of a process executed by the eyeglass-type object recognition device B100 will be described. FIG. 4 is a flowchart showing the flow of the process executed by the eyeglass-type object recognition device B100. In S401, the controller B101 controls to transmit the processing capability information to the learning server A100 through the communication unit B120. In S402, the controller B101 transmits the information about the desired recognition targets to the learning server A100 through the communication unit B120. In S403, the controller B101 determines whether the low-accuracy-model ready notice is received from the learning server A100 through the communication unit B120. When determining that the low-accuracy-model ready notice is not received (No in S403), the controller B101 returns the process to S403 and waits until receiving the low-accuracy-model ready notice. In the meantime, when determining that the low-accuracy-model ready notice is received (Yes in S403), the controller B101 proceeds with the process to S404.

In S404, the controller B101 determines whether a low-accuracy-model obtaining operation is received from a user through the operation unit B104. When determining that the low-accuracy-model obtaining operation is not received (No in S404), the controller B101 returns the process to S404 and waits until receiving the low-accuracy-model obtaining operation. In the meantime, when determining that the low-accuracy-model obtaining operation is received (Yes in S404), the controller B101 proceeds with the process to S405. In S405, the controller B101 transmits the low-accuracy-model obtaining request to the learning server A100 through the communication unit B120.

In S406, the controller B101 determines whether the low-accuracy learned model (low accuracy model) is received from the learning server A100 through the communication unit B120. When determining that the low-accuracy learned model is not received (No in S406), the controller B101 returns the process to S406 and waits until receiving the low-accuracy learned model. In the meantime, when determining that the low-accuracy learned model is received (Yes in S406), the controller B101 proceeds with the process to S407.

In S407, the controller B101 records the low-accuracy learned model received in S406 in the recording medium B110. Thereby, the low-accuracy learned model is mounted on the eyeglass-type object recognition device B100. The controller B101 is able to control the image recognition unit B106 to perform the image recognition by the inference process using the low-accuracy learned model. In S408, the controller B101 determines whether the high-accuracy-model ready notice, which shows that the transmission of the high-accuracy learned model is readied, is received from the learning server A100. When determining that the high-accuracy-model ready notice is not received (No in S408), the controller B101 returns the process to S408 and waits until receiving the high-accuracy-model ready notice. In the meantime, when determining that the high-accuracy-model ready notice is received (Yes in S408), the controller B101 proceeds with the process to S409.

In S409, the controller B101 determines whether a high-accuracy-model obtaining operation, which is a user's request to obtain a high-accuracy learned model, is received from the user through the operation unit B104. When determining that the high-accuracy-model obtaining operation is not received (No in S409), the controller B101 returns the process to S409 and waits until receiving the high-accuracy-model obtaining operation. In the meantime, when determining that the high-accuracy-model obtaining operation is received (Yes in S409), the controller B101 proceeds with the process to S410.

In S410, the controller B101 transmits the high-accuracy-model obtaining request to the learning server A100 through the communication unit B120. In S411, the controller B101 determines whether the high-accuracy learned model (high accuracy model) is received from the learning server A100 through the communication unit B120. When determining that the high-accuracy learned model is not received (No in S411), the controller B101 returns the process to S411 and waits until receiving the high-accuracy learned model. In the meantime, when the result of the determination of S411 is Yes, the controller B101 proceeds with the process to S412.

In S412, the controller B101 records the low-accuracy learned model received in S411 in the recording medium B110. Thereby, the controller 101 is able to control the recognition unit B106 to perform the inference process to which the high-accuracy learned model is applied. On this occasion, the image recognition unit B106 switches the applied learned model from the low-accuracy learned model to the high-accuracy learned model. Thereby, the image recognition unit B106 is able to perform highly accurate image recognition. The image recognition unit B106 performs the image recognition by inputting the image data picked up by the image pickup unit B107 into the high-accuracy learned model. The image recognition unit B106 is able to output the tag information showing a “car”, for example, to the controller B101 as a result of the image recognition.

As mentioned above, the learning server A100 generates the high-accuracy learned model according to the processing capability information and the information about the desired recognition targets that are received from the eyeglass-type object recognition device B100. Since the generated high-accuracy learned model is optimized for the processing capability of the eyeglass-type object recognition device B100 that a user owns, the learned model that is conformed to the performance of the eyeglass-type object recognition device B100 is mounted on the eyeglass-type object recognition device B100.

Furthermore, the learning server A100 selects the optimal learned model from among the low-accuracy learned models prepared beforehand in response to the receipts of the processing capability information and the desired recognition targets form the eyeglass-type object recognition device B100, and transmits the selected model to the eyeglass-type object recognition device B100. Thereby, the function to recognize objects desired by a user can be mounted on the eyeglass-type object recognition device B100 without keeping the user waiting, even when the learning process of a high-accuracy learning model takes time.

In the embodiment mentioned above, the recognition targets by the image recognition unit B106 are registered as the desired recognition targets in the order of priorities. The priorities of the recognition targets may be set up by a user. In such a case, the controller B101 displays a screen that prompts the user to designate the priorities of the respective recognition targets on the display unit B105, for example. Then, the user designates the priorities of the respective recognition targets by operating the operation unit B104 on the basis of the screen displayed on the display unit B105. The controller B101 may generate a list of the desired recognition targets according to the designated priorities.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)″), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-026507, filed Feb. 19, 2020, which is hereby incorporated by reference herein in its entirety.

What is claimed is:

1. A learning apparatus comprising:
a reception unit configured to receive information about processing capability and at least one recognition target of an image recognition apparatus from the image recognition apparatus concerned;
an adjustment unit configured to adjust a configuration of a learning model applied to image recognition of the at least one recognition target so as to satisfy the processing capability;
a learning unit configured to generate a first learned model that is able to recognize the at least one recognition target by performing machine learning of the adjusted learning model; and
a transmission unit configured to transmit the first learned model to the image recognition apparatus.

2. The learning apparatus according to claim 1, wherein the adjustment unit adjusts the configuration of the learning model so that a data size and a calculation amount of the learning model will satisfy the processing capability.

3. The learning apparatus according to claim 1, wherein the at least one recognition target comprises a plurality of recognition targets, and
wherein the adjustment unit selects the learning model to be adjusted from among learning models recorded in a recording unit for the respective processing capabilities and for the respective recognition targets.

4. The learning apparatus according to claim 1, wherein the at least one recognition target comprises a plurality of recognition targets,
wherein the adjustment unit adjusts the configuration of the learning model by excepting from a recognition target that has a lowest priority from among the plurality of recognition targets in a case where the machine learning does not converge, and
wherein the learning unit generates the first learned model by performing the machine learning of the adjusted learning model.

5. The learning apparatus according to claim 4, wherein the adjustment unit adjusts the configuration of the learning model by repeatedly excepting a recognition target until the machine learning converges.

6. The learning apparatus according to claim 5, wherein the priority is designated from a screen that prompts designation of the priority about each of the plurality of recognition targets.

7. The learning apparatus according to claim 1, wherein the transmission unit transmits a second learned model, which is lower than the first learned model in accuracy and satisfies the processing capability so as to enable image recognition of the at least one recognition target, to the image recognition apparatus before transmitting the first learned model to the image recognition apparatus.

8. The learning apparatus according to claim 1, wherein the adjustment unit performs a process to reduce a scale of the first learned model, and
wherein the transmission unit transmits the first learned model to the image recognition apparatus in a case where the first learned model of which the scale is reduced satisfies the processing capability.

9. The learning apparatus according to claim 1, wherein the first learned model is deleted in a case where a request to obtain the first learned model is not received from the image recognition apparatus within a predetermined period.

10. The learning apparatus according to claim 1, wherein the learning model is a convolutional neural network model.

11. The learning apparatus according to claim 10, wherein the adjustment unit adjusts at least one of the number of synapses, the number of layers, a grain size of an output value of a firing function of the convolutional neural network model.

12. An image recognition apparatus comprising:
a transmission unit configured to transmit information about processing capability and at least one recognition target of the image recognition apparatus to a learning apparatus;
a reception unit configured to receive a learned model that is able to recognize the at least one recognition target and is generated by adjusting a configuration of a learning model applied to image recognition of the at least one recognition target so as to satisfy the processing capability and by performing machine learning of the adjusted learning model; and
an image recognition unit configured to perform the image recognition using the learned model.

13. A control method for a learning apparatus, the control method comprising:
a step of receiving information about processing capability and at least one recognition target of an image recognition apparatus from the image recognition apparatus concerned;
a step of adjusting a configuration of a learning model applied to image recognition of the at least one recognition target so as to satisfy the processing capability;
a step of generating a learned model that is able to recognize the at least one recognition target by performing machine learning of the adjusted learning model; and
a step of transmitting the first learned model to the image recognition apparatus.

14. A control method for an image recognition apparatus, the control method comprising:
a step of transmitting information about processing capability and at least one recognition target of the image recognition apparatus to a learning apparatus;
a step of receiving a learned model that is able to recognize the at least one recognition target and is generated by adjusting a configuration of a learning model applied to image recognition of the at least one recognition target so as to satisfy the processing capability and by performing machine learning of the adjusted learning model; and
a step of performing the image recognition using the learned model.

15. A non-transitory computer-readable storage medium storing a control program causing a computer to execute a control method for a learning apparatus, the control method comprising:
a step of receiving information about processing capability and at least one recognition target of an image recognition apparatus from the image recognition apparatus concerned;
a step of adjusting a configuration of a learning model applied to image recognition of the at least one recognition target so as to satisfy the processing capability;
a step of generating a learned model that is able to recognize the at least one recognition target by performing machine learning of the adjusted learning model; and
a step of transmitting the first learned model to the image recognition apparatus.

16. A non-transitory computer-readable storage medium storing a control program causing a computer to execute a control method for an image recognition apparatus, the control method comprising:
a step of transmitting information about processing capability and at least one recognition target of the image recognition apparatus to a learning apparatus;
a step of receiving a learned model that is able to recognize the at least one recognition target and is generated by adjusting a configuration of a learning model applied to image recognition of the at least one recognition target so as to satisfy the processing capability and by performing machine learning of the adjusted learning model; and
a step of performing the image recognition using the learned model.
